(19) United States
(12) Patent Application Publication
(10) Pub. No.: US 2016/0283111 A1
(43) Pub. Date: Sep. 29, 2016

(54) READ OPERATIONS IN MEMORY DEVICES

(71) Applicant: Intel Corporation, Santa Clara, CA (US)

(72) Inventors: Xin Guo, San Jose, CA (US); David B. Carlton, Oakland, CA (US); Scott Nelson, Vancouver (CA); David J. Pelster, Longmont, CO (US); Donia Sebastian, Fair Oaks, CA (US)

(73) Assignee: Intel Corporation, Santa Clara, CA (US)

(21) Appl. No.: 14/670,250

(22) Filed: Mar. 26, 2015

(51) Int. Cl. G06F 3/06

(52) U.S. Cl. CPC G06F 3/061; G06F 3/0688; G06F 3/0655

(57) ABSTRACT

Apparatus, systems, and methods to implement read operations in nonvolatile memory devices are described. In one example, a controller comprises logic to receive a first read request from a host device, place the first read request in a read queue comprising a plurality of read requests directed to the nonvolatile memory, determine a first target die and a first target plane in the nonvolatile memory for the first read request and combine the first read request with at least a second read request in the read queue to form a combined read request, wherein the second read request comprise a second target die, which is the same as the first target die, and a second target plane which is different from the first target plane. Other examples are also disclosed and claimed.

### FIELD

The present disclosure generally relates to the field of electronics. More particularly, aspects generally relate to read operations in memory devices.

### BACKGROUND

Solid state drives (SSDs) or nonvolatile direct in-line memory modules (NV-DIMMs) provide high speed, nonvolatile memory capacity without the need for moving parts. SSDs rely on concurrency in read and write operations to increase performance. Memory in a SSD commonly comprises multiple physically separate “dies” that can be read from in parallel to improve performance. As manufacturers move to increasingly larger die sizes, smaller SSDs require fewer dies in them for a given memory density. This reduces the ability to utilize concurrency to improve read performance. This has a negative effect on performance. Accordingly, techniques to manage read operations in memory devices may find utility, e.g., in memory systems for electronic devices.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 is a schematic, block diagram illustration of components of an apparatus in which read operations in memory devices may be implemented in accordance with various examples discussed herein.

FIG. 2 is a schematic, block diagram illustration of a memory in accordance with various examples discussed herein.

FIG. 3 is a schematic illustrations of mapping read operations into a memory in accordance with various examples discussed herein.

FIGS. 4-5 are schematic illustrations of operations in methods to implement read operations in nonvolatile memory devices in accordance with various examples discussed herein.

FIGS. 6-10 are schematic, block diagram illustrations of electronic devices which may be adapted to implement read operations in nonvolatile memory devices in accordance with various examples discussed herein.

### DETAILED DESCRIPTION

In the following description, numerous specific details are set forth in order to provide a thorough understanding of various examples. However, various examples may be practiced without the specific details. In other instances, well-known methods, procedures, components, and circuits have not been described in detail so as not to obscure the particular examples. Further, various aspects of examples may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

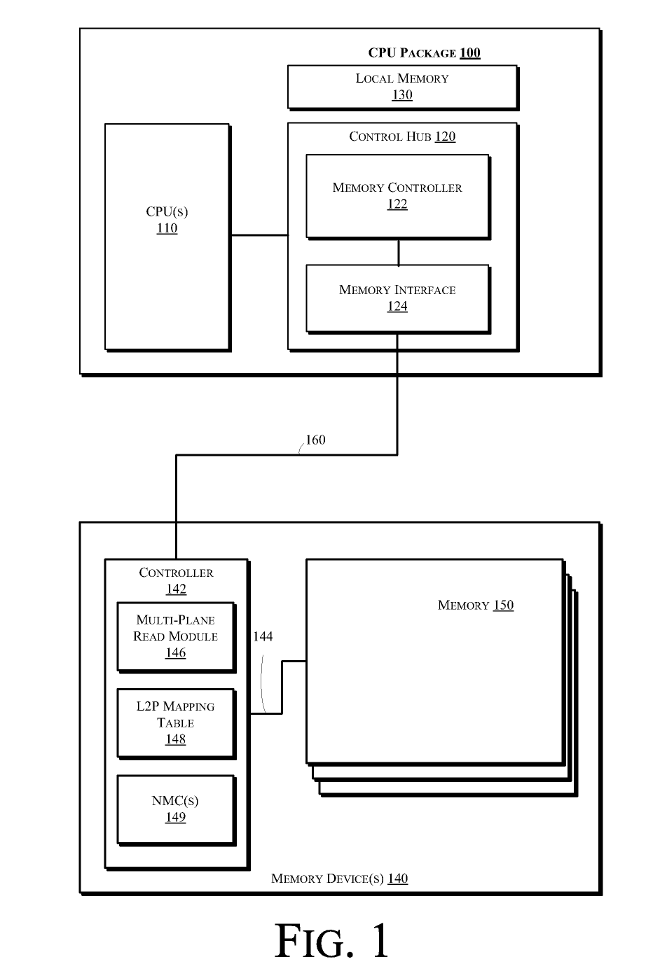

As described in detail below, by adroitly combining read operation in a read queue read operations directed to different planes on a single die may executed concurrently, thereby increasing performance parameters of a SSD. Specific details of a systems and methods to manage read devices in electronic devices will be described below with reference to FIGS. 1-10.

FIG. 1 is a schematic, block diagram illustration of components of an apparatus in which methods to manage nonvolatile memory devices may be implemented in accordance with various examples discussed herein. Referring to FIG. 1, in some examples a central processing unit (CPU) package 100 which may comprise one or more CPUs 110 coupled to a control hub 120 and a local memory 130. Control hub 120 comprises a memory controller 122 and a memory interface 124. In some examples the control hub 120 may be integrated with the processor(s) 110.

Memory interface 124 is coupled to one or more remote memory devices 140 by a communication bus 160. Storage device 140 may be implemented as a solid state drive (SSD), a nonvolatile direct in-line memory module (NV-DIMM) or the like and comprise a controller 142 and memory 150. In various examples, at least some of the memory 150 may comprise nonvolatile memory, e.g., NAND (flash) memory, ferroelectric random-access memory (FeTRAM), nanowire-based non-volatile memory, memory that incorporates memristor technology, a static random access memory (SRAM), three dimensional (3D) cross point memory, phase change memory (PCM), spin-transfer torque memory (STT-RAM) or NAND memory or NOR memory. The specific configuration of the memory 150 in the memory device(s) 140 is not critical. In such embodiments the memory interface may comprise a Serial ATA interface, a PCI Express (PCIE) to 100 interface, or the like.

Controller 142 may comprise logic, at least partially including hardware logic, defining a multi-plane read module 146. Further, controller 142 may maintain a logical address to physical address mapping table 148 which maps a logical address received with a read request to a physical address in the nonvolatile memory and one or more NAND media channels 248, which are coupled to memory 150 via communication link 144

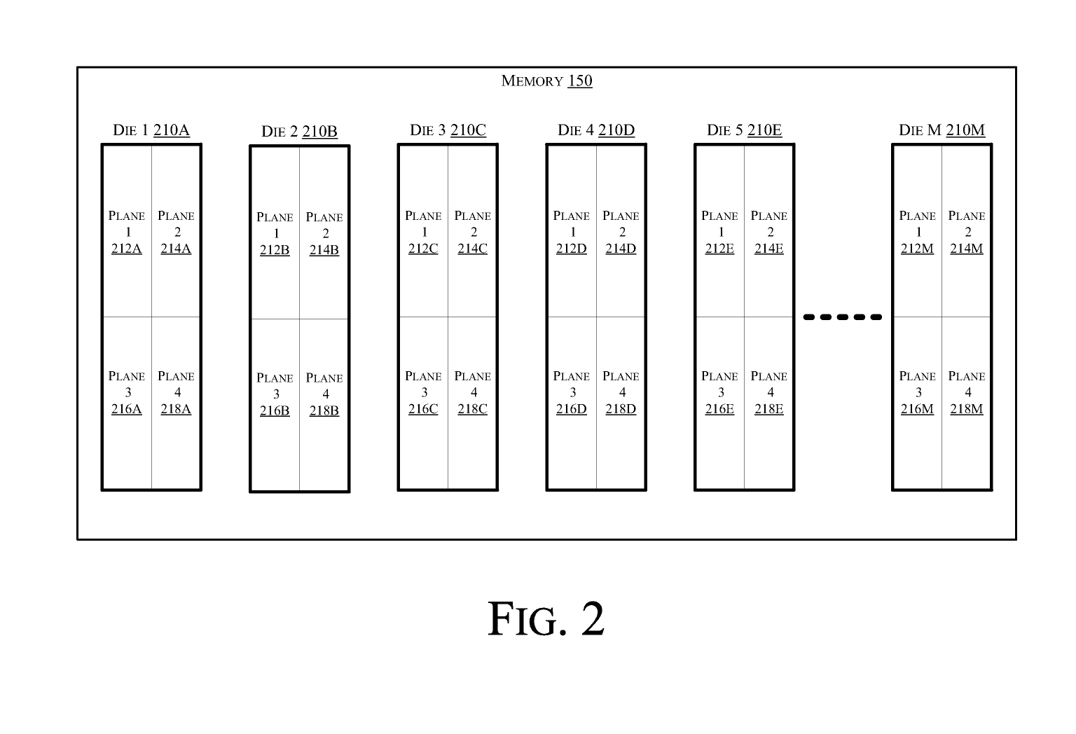

FIG. 2 is a schematic, block diagram illustration of a memory such as memory 150 in accordance with various examples discussed herein. Referring to FIG. 2, in some examples memory 150 may comprise a plurality of dies, each of which is subdivided into a number of planes. In the example depicted in FIG. 2 the memory 150 comprises a number M dies, each of which is divided into four planes. Thus, die 1 210A comprises plane 1 212A, plane 2 212B, plane 3 212C, and plane 4 212D. Similarly die 2 210B through die M 210M each comprise four planes.

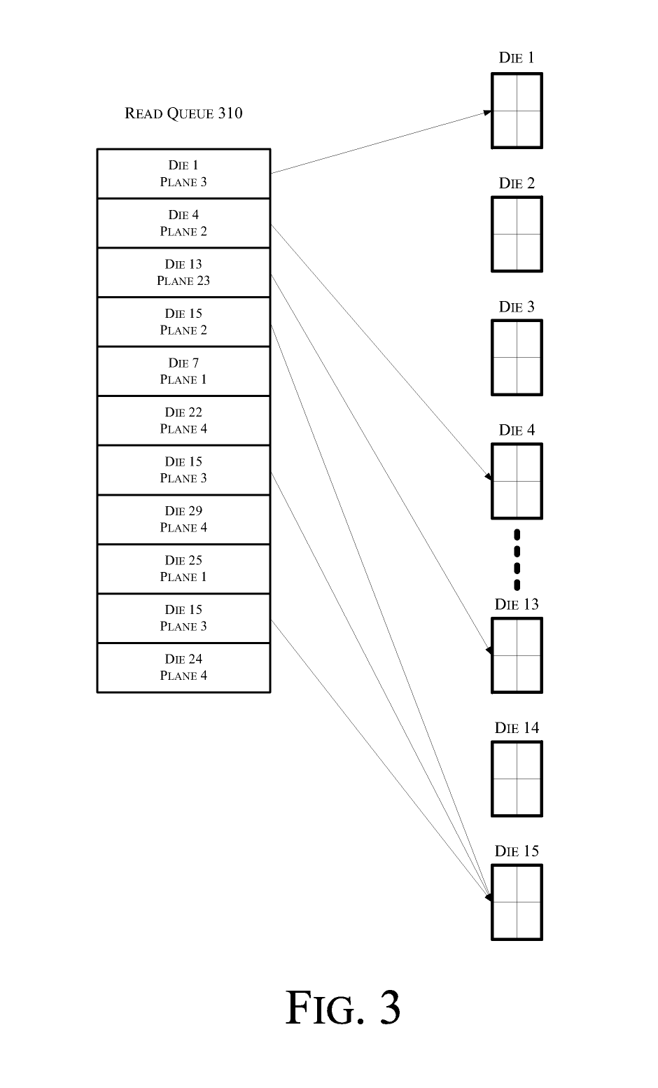

Operations implemented by controller 142 will be described with reference to FIGS. 3 and 4-5. Referring briefly to FIG. 3, read operations received in controller 142 may be placed in a read queue 310. Read queue may be implemented as a logical structure, e.g., an array, in controller 142, and controller 142 may select read operations from read queue in any order for execution against the memory 150.

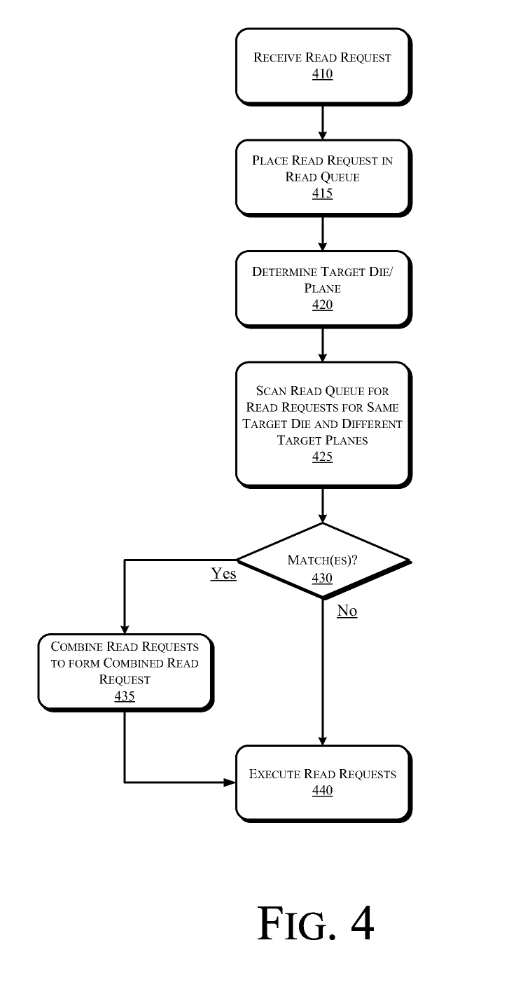

Referring to FIG. 4, at operation 410 the controller 142 receives a read request from a host device, e.g., memory controller 122, directed to memory 150. At operation 415, the controller 142 places the read operation in read queue 310. Thus, in operation, read queue 310 may comprise a plurality of read requests directed to memory 150.

At operation 420 the controller 142 determines a target die and a target plane for read operations received from the host device. For example, read operations may arrive from the host device with a logical memory address assigned by the host device. The controller 142 may reference the logical memory address in the logical to physical mapping table 148 to obtain a physical address in the memory 150 from which data in the read operation is to be retrieved. The die and plane information may be associated with the physical address in the read queue. Thus, referring to FIG. 3, the respective read requests in the read queue may each have a die and a plane on the die associated with them. For example, if the die includes four planes then two bits of the physical address may be used to identify the plane associated with the request. Similarly, if the memory includes 24 dies, then 5 bits of the physical address may be used to identify the die.

At operation 425 the controller 142 scans the read queue 310 for read requests that are directed to the same target die but to different planes on the target die. If, at operation 430 there are no matches then control passes to operation 440 and the controller 142 executes read operations in accordance with normal operations, e.g., the read operations may be executed in a first-in, first-out (FIFO) manner.

By contrast, if at operation 430 there are matches, then control passes to operation 435 and the controller 142 combines matching read requests to form a combined read request. For example, referring to FIG. 2, the controller 142 may scan the read queue 310 and identify that there are three read requests directed to die 15. A first read request directed to die 15 is directed to plane 2, a second read request is directed to plane 1, and a third read request is directed to plane 3. In this scenario, at operation 430 the controller 142 will combine the three read requests directed to die 15 and execute the read requests concurrently (operation 440). In some examples the controller 142 may associate a unique identifier (e.g., a tag) with each of the separate read requests that are combined to form a combined read request.

The controller 142 must allow commands with four fully independent physical address fields (one for each plane) in order to permit multi plane reads to be sent to memory 150. In some examples controller 142 may enable a multiplane read mode in which the plane 2/3/4 transfer buffer destination address fields are used for the plane 2/3/4 page address.

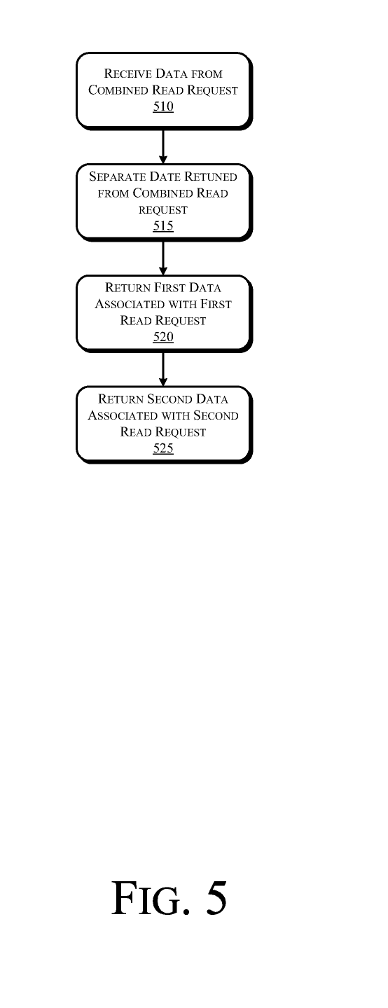

FIG. 5 is a flowchart illustrating operations applied to data returned from a combined read request. Referring to FIG. 5, at operation 510 data retrieved from memory 150 as a result of a combined read request is received at controller 142. At operation 520 the controller 142 separates the data retrieved from the separate the data retrieved from the combined read request such that the data is associated with the original read request. For example, data retrieved from memory in response to a combined read request may be separated into first data associated with a first read request and second data associated with a second read request, third data associated with a third read request, and fourth data associated with a fourth read request. In some examples the controller 142 may use the unique identifier (e.g., tag) associated with the data in the combined read request to separate the data retrieved from the combined read request.

At operation 520 the controller returns data associated with the first read request to the host which generated the first read request, and at operation 525 the controller 142 returns the second data associated with the second read request to a host which generated the second read request. One skilled in the art will recognize that in cases where more than two read requests are combined to form a combined read request the controller may return third data associated with a third read request and/or fourth data associated with a fourth read request.

Some existing controllers such as controller 142 may be limited to using a single same page address for each plane due to a matching limitation in the NAND media. In order to accommodate this limitation, an independent multi-plane read mode may be added to the NAND Media Channel (NMC) block. As described above, in some examples a multi-plane read mode may use the plane 2/3/4 transfer buffer destination address fields to use for the plane 2/3/4 page address.

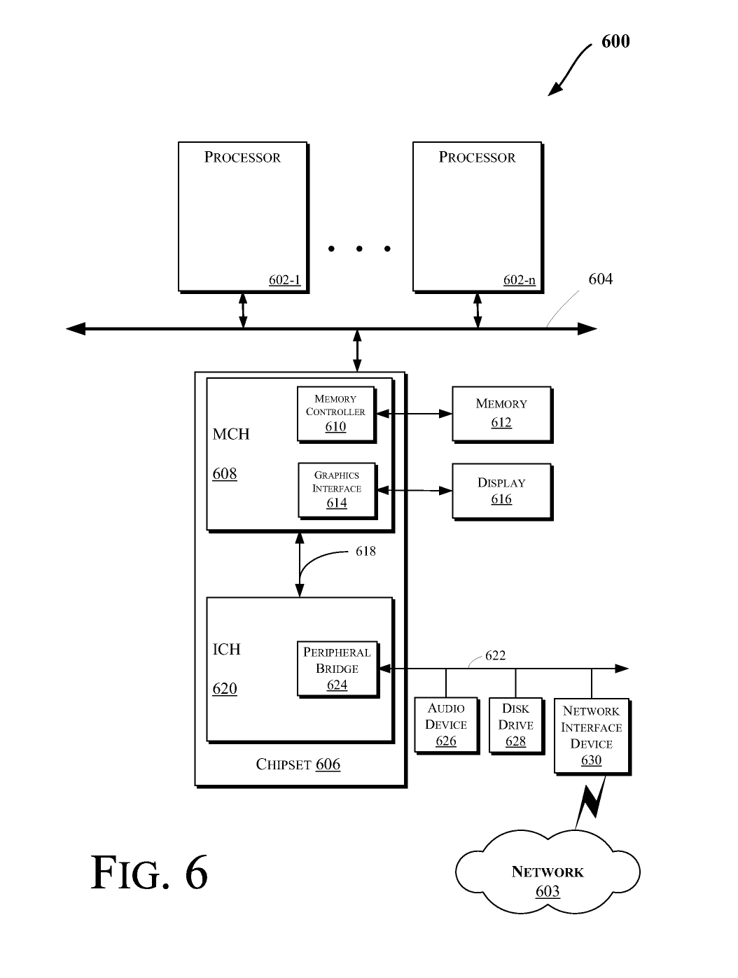

As described above, in some examples the electronic device may be embodied as a computer system. FIG. 6 illustrates a block diagram of a computing system 600 in accordance with an example. The computing system 600 may include one or more central processing unit(s) (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an example, one or more of the processors 602 may be the same or similar to the processors 102 of FIG. 1. For example, one or more of the processors 602 may include the control unit 120 discussed with reference to FIGS. 1-3. Also, the operations discussed with reference to FIGS. 3-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 412 may store data, including sequences of instructions, that may be executed by the CPU 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

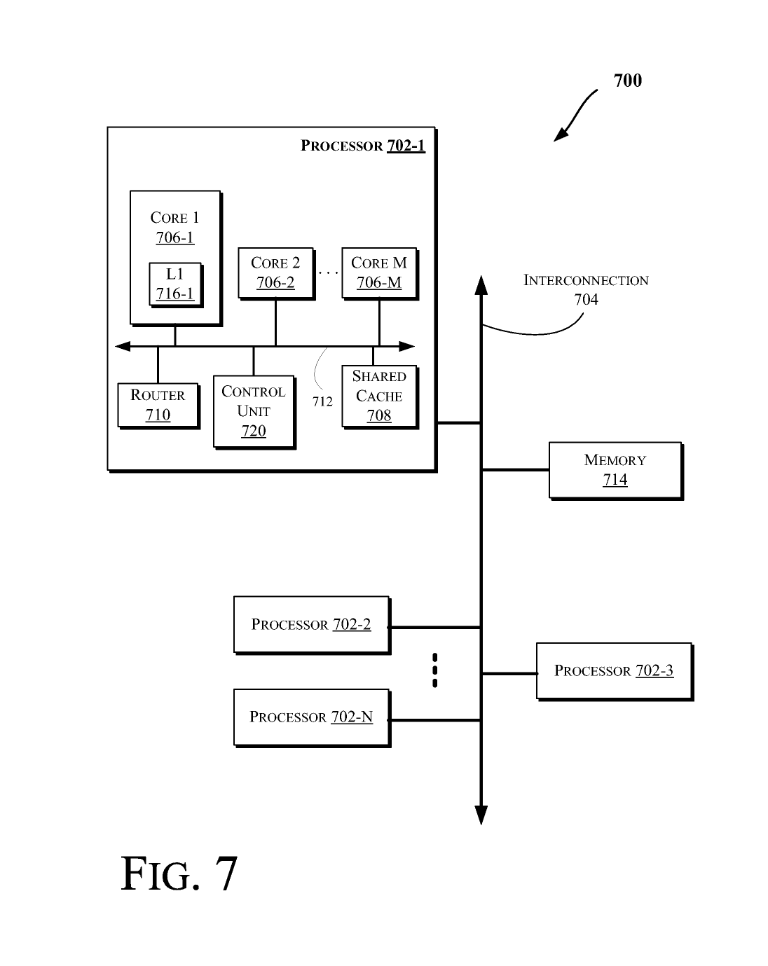

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”). In one example, the control unit 720 may include logic to implement the operations described above with reference to the memory controller 122 in FIG. 2.

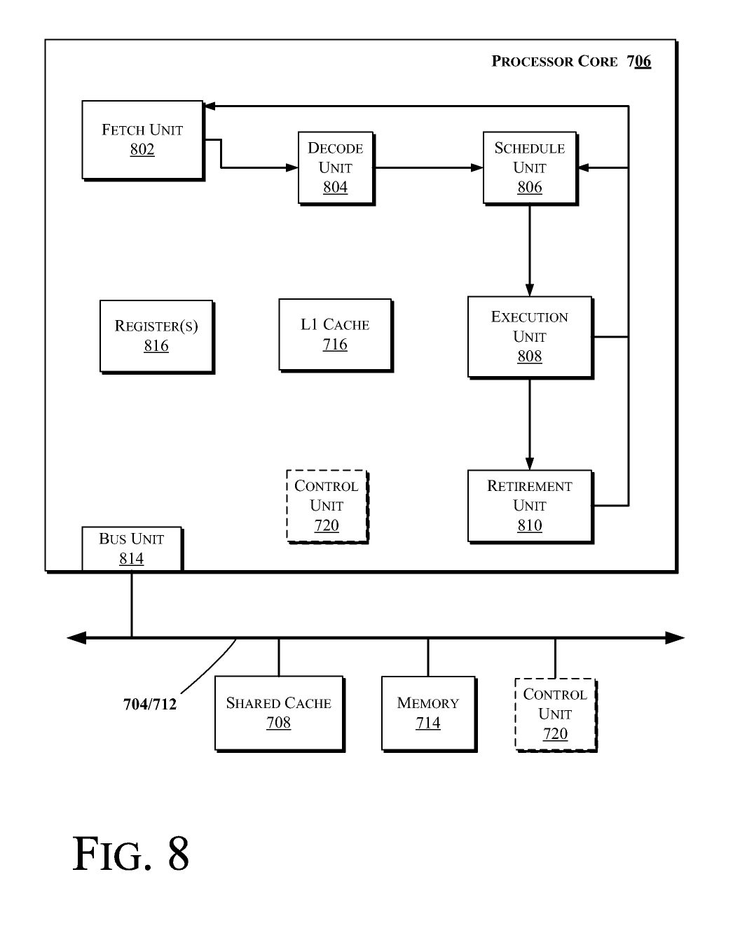

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

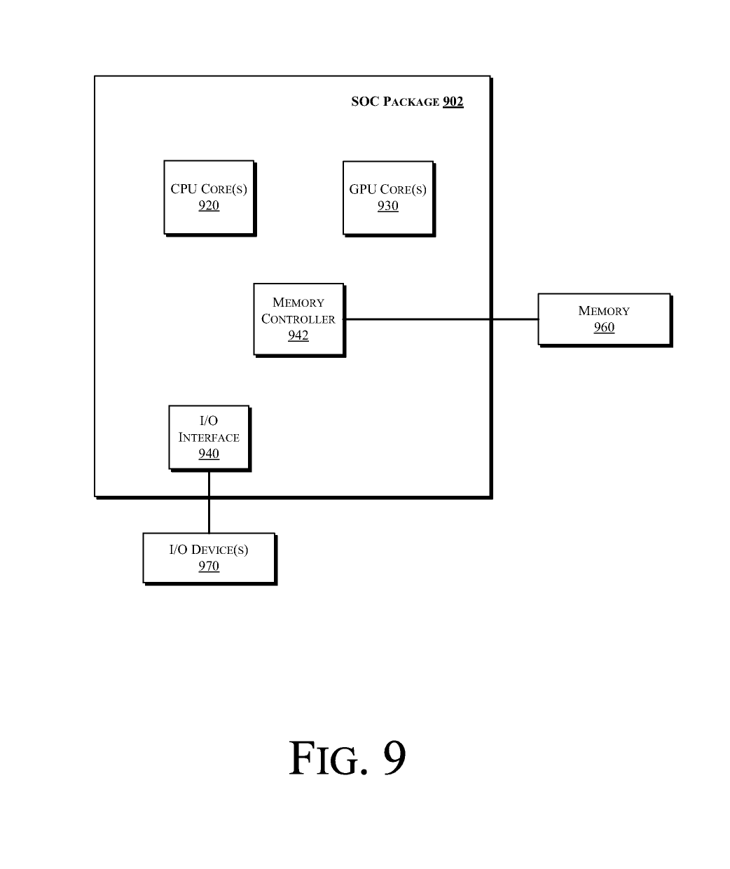

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more Central Processing Unit (CPU) cores 920, one or more Graphics Processor Unit (GPU) cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch screen, a speaker, or the like.

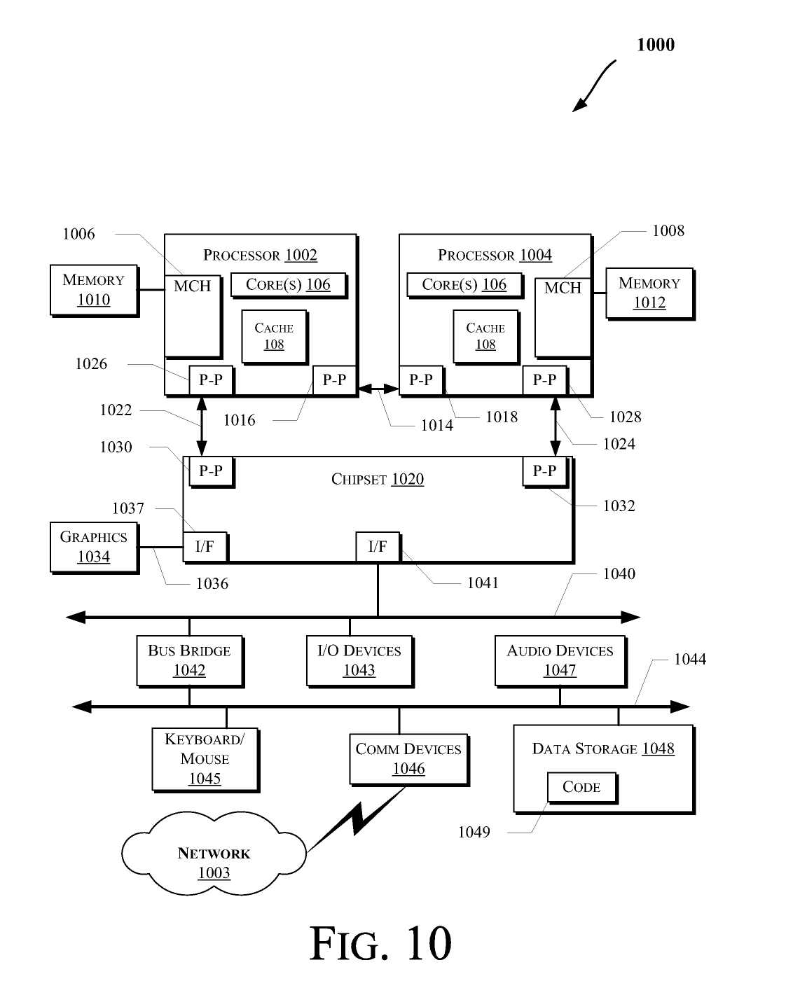

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces. The operations discussed with reference to FIG. 2 may be performed by one or more components of the system 1000.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012. MCH 1006 and 1008 may include the memory controller 120 and/or logic of FIG. 1 in some examples.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1002 and 1004. Other examples, however, may exist in other circuits, logic units, or devices within the system 1000 of FIG. 10. Furthermore, other examples may be distributed throughout several circuits, logic units, or devices illustrated in FIG. 10.

The chipset 1020 may communicate with a bus 1040 using a point-to-point PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 803), audio I/O device, and/or a data storage device 1048. The data storage device 1048 (which may be a hard disk drive or a NAND flash based solid state drive) may store code 1049 that may be executed by the processors 1002 and/or 1004.

The following pertains to further examples.

Example 1 is an electronic device comprising at least one processor, at least one storage device comprising a nonvolatile memory, and a controller coupled to the memory and comprising logic, at least partially including hardware logic, to receive a first read request from a host device, place the first read request in a read queue comprising a plurality of read requests directed to the nonvolatile memory, determine a first target die and a first target plane in the nonvolatile memory for the first read request, and combine the first read request with at least a second read request in the read queue to form a combined read request, wherein the second read request comprises a second target die, which is the same as the first target die, and a second target plane which is different from the first target plane.

In Example 2, the subject matter of Example 1 can optionally include logic, at least partially including hardware logic, to execute the combined read request to retrieve data from the nonvolatile memory requested in the combined read request.

In Example 3, the subject matter of any one of Examples 1-2 can optionally include logic, at least partially including hardware logic, to separate the data retrieved from the combined read request into to first data associated with the first read request and second data associated with the second read request

In Example 4, the subject matter of any one of Examples 1-3 can optionally include logic, at least partially including hardware logic, to return the first data associated with the first read request to a host which generated the first read request and return the second data associated with the second read request to a host which generated the second read request.

In Example 5, the subject matter of any one of Examples 1-4 can optionally include logic, at least partially including hardware logic, to combine the first read request and the second read request in the read queue with at least a third read request in the read queue.

In Example 6, the subject matter of any one of Examples 1-5 can optionally include logic, at least partially including hardware logic, to maintain a logical address to physical address mapping table which maps a logical address received with a read request to a physical address in the nonvolatile memory.

In Example 7, the subject matter of any one of Examples 1-6 can optionally include an arrangement in which one or more physical addresses in the nonvolatile memory are associated with a die and a plane in the nonvolatile memory.

Example 8 is a storage device, comprising a nonvolatile memory, and a controller coupled to the memory and comprising logic, at least partially including hardware logic, to receive a first read request from a host device, place the first read request in a read queue comprising a plurality of read requests directed to the nonvolatile memory, determine a first target die and a first target plane in the nonvolatile memory for the first read request, and combine the first read request with at least a second read request in the read queue to form a combined read request, wherein the second read request comprises a second target die, which is the same as the first target die, and a second target plane which is different from the first target plane.

In Example 9, the subject matter of Example 8 can optionally include logic, at least partially including hardware logic, to execute the combined read request to retrieve data from the nonvolatile memory requested in the combined read request.

In Example 10, the subject matter of any one of Examples 8-9 can optionally include logic, at least partially including hardware logic, to separate the data retrieved from the combined read request into to first data associated with the first read request and second data associated with the second read request

In Example 11, the subject matter of any one of Examples 8-10 can optionally include logic, at least partially including hardware logic, to return the first data associated with the first read request to a host which generated the first read request and return the second data associated with the second read request to a host which generated the second read request.

In Example 12, the subject matter of any one of Examples 8-11 can optionally include logic, at least partially including hardware logic, to combine the first read request and the second read request in the read queue with at least a third read request in the read queue.

In Example 13, the subject matter of any one of Examples 8-12 can optionally include logic, at least partially including hardware logic, to maintain a logical address to physical address mapping table which maps a logical address received with a read request to a physical address in the nonvolatile memory.

In Example 14, the subject matter of any one of Examples 8-13 can optionally include an arrangement in which one or more physical addresses in the nonvolatile memory are associated with a die and a plane in the nonvolatile memory.

Example 15 is a controller coupled to the memory and comprising logic, at least partially including hardware logic, to receive a first read request from a host device, place the first read request in a read queue comprising a plurality of read requests directed to the nonvolatile memory, determine a first target die and a first target plane in the nonvolatile memory for the first read request, and combine the first read request with at least a second read request in the read queue to form a combined read request, wherein the second read request comprises a second target die, which is the same as the first target die, and a second target plane which is different from the first target plane.

In Example 16, the subject matter of Example 15 can optionally include logic, at least partially including hardware logic, to execute the combined read request to retrieve data from the nonvolatile memory requested in the combined read request.

In Example 17, the subject matter of any one of Examples 15-16 can optionally include logic, at least partially including hardware logic, to separate the data retrieved from the combined read request into to first data associated with the first read request and second data associated with the second read request

In Example 18, the subject matter of any one of Examples 15-17 can optionally include logic, at least partially including hardware logic, to return the first data associated with the first read request to a host which generated the first read request and return the second data associated with the second read request to a host which generated the second read request.

In Example 19, the subject matter of any one of Examples 15-18 can optionally include logic, at least partially including hardware logic, to combine the first read request and the second read request in the read queue with at least a third read request in the read queue.

In Example 20, the subject matter of any one of Examples 15-19 can optionally include logic, at least partially including hardware logic, to maintain a logical address to physical address mapping table which maps a logical address received with a read request to a physical address in the nonvolatile memory.

In Example 21, the subject matter of any one of Examples 15-20 can optionally include an arrangement in which one or more physical addresses in the nonvolatile memory are associated with a die and a plane in the nonvolatile memory.

In various examples, the operations discussed herein, e.g., with reference to FIGS. 1-10, may be implemented as hardware (e.g., circuitry), software, firmware, microcode, or combinations thereof, which may be provided as a computer program product, e.g., including a tangible (e.g., non-transitory) machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed herein.

Reference in the specification to “one example” or “an example” means that a particular feature, structure, or characteristic described in connection with the example may be included in at least an implementation. The appearances of the phrase “in one example” in various places in the specification may or may not be all referring to the same example.

Also, in the description and claims, the terms “coupled” and “connected,” along with their derivatives, may be used. In some examples, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although examples have been described in language specific to structural features and/or methodological acts, it is to be understood that claimed subject matter may not be limited to the specific features or acts described. Rather, the specific features and acts are disclosed as sample forms of implementing the claimed subject matter.

1. An electronic device, comprising:
at least one processor; and
at least one storage device comprising a nonvolatile memory; and
a controller coupled to the memory and comprising logic, at least partially including hardware logic, to:
receive a first read request from a host device;
place the first read request in a read queue comprising a plurality of read requests directed to the nonvolatile memory;
determine a first target die and a first target plane in the nonvolatile memory for the first read request; and
combine the first read request with at least a second read request in the read queue to form a combined read request, wherein the second read request comprises a second target die, which is the same as the first target die, and a second target plane which is different from the first target plane.

2. The electronic device of claim 1, wherein the controller comprises logic, at least partially including hardware logic, to:
execute the combined read request to retrieve data from the nonvolatile memory requested in the combined read request.

3. The electronic device of claim 2, wherein the controller comprises logic, at least partially including hardware logic, to:
separate the data retrieved from the combined read request into to first data associated with the first read request and second data associated with the second read request.

4. The electronic device of claim 3, wherein the controller comprises logic, at least partially including hardware logic, to:
return the first data associated with the first read request to a host which generated the first read request; and
return the second data associated with the second read request to a host which generated the second read request.

5. The electronic device of claim 1, wherein the controller comprises logic, at least partially including hardware logic, to:
combine the first read request and the second read request in the read queue with at least a third read request in the read queue.

6. The electronic device of claim 1, wherein the controller comprises logic, at least partially including hardware logic, to:
maintain a logical address to physical address mapping table which maps a logical address received with a read request to a physical address in the nonvolatile memory.

7. The electronic device of claim 1, wherein one or more physical addresses in the nonvolatile memory are associated with a die and a plane in the nonvolatile memory.

8. A storage device, comprising:
a nonvolatile memory; and
a controller coupled to the memory and comprising logic, at least partially including hardware logic, to:
receive a first read request from a host device;
place the first read request in a read queue comprising a plurality of read requests directed to the nonvolatile memory;
determine a first target die and a first target plane in the nonvolatile memory for the first read request; and
combine the first read request with at least a second read request in the read queue to form a combined read request, wherein the second read request comprise a second target die, which is the same as the first target die, and a second target plane which is different from the first target plane.

9. The storage device of claim 8, wherein the controller comprises logic, at least partially including hardware logic, to:
execute the combined read request to retrieve data from the nonvolatile memory requested in the combined read request.

10. The storage device of claim 9, wherein the controller comprises logic, at least partially including hardware logic, to:
separate the data retrieved from the combined read request into to first data associated with the first read request and second data associated with the second read request.

11. The storage device of claim 10, wherein the controller comprises logic, at least partially including hardware logic, to:
return the first data associated with the first read request to a host which generated the first read request; and
return the second data associated with the second read request to a host which generated the second read request.

12. The storage device of claim 8, wherein the controller comprises logic, at least partially including hardware logic, to:
combine the first read request and the second read request in the read queue with at least a third read request in the read queue.

13. The storage device of claim 8, wherein the controller comprises logic, at least partially including hardware logic, to:
maintain a logical address to physical address mapping table which maps a logical address received with a read request to a physical address in the nonvolatile memory.

14. The storage device of claim 8, wherein one or more physical addresses in the nonvolatile memory are associated with a die and a plane in the nonvolatile memory.

15. A controller comprising logic, at least partially including hardware logic, to:
receive a first read request from a host device;
place the first read request in a read queue comprising a plurality of read requests directed to the nonvolatile memory;
determine a first target die and a first target plane in the nonvolatile memory for the first read request; and
combine the first read request with at least a second read request in the read queue to form a combined read request, wherein the second read request comprise a second target die, which is the same as the first target die, and a second target plane which is different from the first target plane.

16. The controller of claim 15, wherein the controller comprises logic, at least partially including hardware logic, to:
execute the combined read request to retrieve data from the nonvolatile memory requested in the combined read request.

17. The controller of claim 16, wherein the controller comprises logic, at least partially including hardware logic, to:
separate the data retrieved from the combined read request into to first data associated with the first read request and second data associated with the second read request.

18. The controller of claim 17, wherein the controller comprises logic, at least partially including hardware logic, to:
return the first data associated with the first read request to a host which generated the first read request; and
return the second data associated with the second read request to a host which generated the second read request.

19. The controller of claim 18, wherein the controller comprises logic, at least partially including hardware logic, to:
combine the first read request and the second read request in the read queue with at least a third read request in the read queue.

20. The controller of claim 15, wherein the controller comprises logic, at least partially including hardware logic, to:
maintain a logical address to physical address mapping table which maps a logical address received with a read request to a physical address in the nonvolatile memory.

21. The controller of claim 15, wherein one or more physical addresses in the nonvolatile memory are associated with a die and a plane in the nonvolatile memory.
